(19) United States
(12) Patent Application Publication
(10) Pub. No.: US 2005/0076147 A1
(43) Pub. Date: Apr. 7, 2005

(54) NMEA 0183 sentence transporter over ethernet

(76) Inventors: Michael E. Blake, (US); Christopher M. Wiencek, (US)

Correspondence Address: MICHAEL EMERSON BLAKE, 3900 SW 30TH AVE STE 4, FORT LAUDERDALE, FL, 33312, US

(21) Appl. No.: 10/668,131

(22) Filed: Sep. 24, 2003

(51) Int. Cl. G06F 15/173; G06F 15/16

(52) U.S. Cl. 709/246; 709/238

(57) ABSTRACT

An interface controller that connects devices which read and write the NMEA 0183 sentence data in a RS422 electrical format, to the Ethernet for transmission. NMEA 0183 sentence data is encapsulated and routed to other interface controllers, and/or to user applications operating on computers. A software interface utility designed to operate on the same computer as the users application programs will provide the transparency and the routing/mapping between the Ethernet transmitted NMEA 0183 sentence data and the users application programs communications interface, transparently.

### FIELD OF THE INVENTION

The present invention relates to the transmission of NMEA 0183 sentence data and, more particularly, to transmitting this NMEA 0183 data over the Ethernet while allowing for complete transparency to the user's equipment, and to the software applications needing access to NMEA 0183 sentence data.

### BACKGROUND OF THE INVENTION

NMEA 0183 is a standard data sentence format designed to enable various manufacturers of navigation equipment and software to share data. This is the most used format world-wide for the sharing of data such as latitude, longitude, depth, winds, waypoints, heading, data/time, speeds, etc. Standard NMEA 0183 sentence data transmission is defined as 4800 baud, transmitting over the RS422 electrical standard. This slow speed of transmission of data from the NMEA navigation devices is restrictive to today's needs. Multiple listeners (Navigation Devices) are limited to three users. Multiple COM ports on personal computers must be reserved for each NMEA 0183 transmitting device which increases costs and complexity.

Hardware NMEA 0183 multiplexors are limited to the number of inputs that they can support, are not Ethernet compatible and have potential buffer over runs as a result of the restriction of the 4800 baud on outputs.

It is therefore an object of the invention to increase the transmission speed of the NMEA 0183 data from its present speed of 4800 baud to the high speed of the Ethernet.

It is another object of the invention to provide for dynamic routing and identification of this NMEA 0183 data by encapsulating of NMEA 0183 sentences with a proprietary header.

It is another object of the invention to provide a software utility that is the bridge between the Ethernet NMEA 0183 sentence data and the user applications which operate on computers, with complete transparency in operation.

It is another object of the invention to allow user configurable parameters of the invention's controller via a software utility.

### SUMMARY OF THE INVENTION

In accordance with the present invention, there is provided an interface controller which adapts the NMEA 0183 sentence data from an RS422 electrical format to the Ethernet. Sentence data is encapsulated and routed to other interface controllers, and/or to user applications operating on computers, via the invention's transparent utility program. This transparent program provides the interface between the NMEA 0183 sentence Ethernet packet and the user programs by routing the data to Virtual COM ports dynamically created by the utility program, while operating on computers. The GUI (Graphics User Interface) of the utility program allows for user mapping of the Virtual COM ports and the NMEA 0183 sentences, among other user interface options.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a block diagram showing the components view of an interface controller, the RS422 NMEA 0183 devices and the Ethernet;

FIG. 2 is a block diagram of the input process logic view of an interface controller;

FIG. 3 is a block diagram of the output process logic view of an interface controller;

FIG. 4 is a data packet diagram view of an Ethernet record created by the controller and by the interface utility program on the computer;

FIG. 5 is a data element view of an Ethernet packet record field details created by this invention; and

FIG. 6 is a block system logic diagram view of a program logic view of the system utility program that interfaces the NMEA 0183 Ethernet packets and the user applications running on the computer.

For purposes of clarity and brevity, like elements and components will bear the same designations and numbering throughout the FIGURES.

### DESCRIPTION OF THE PREFERRED EMBODIMENT

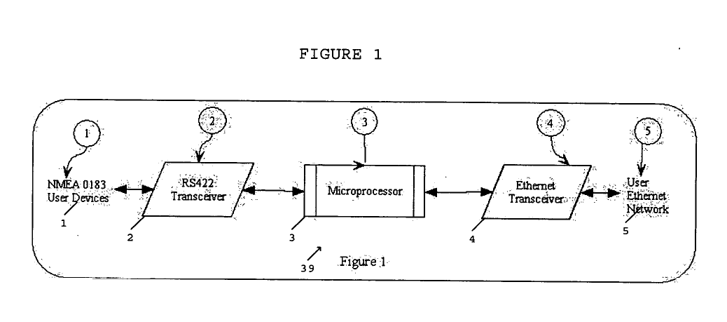

FIG. 1 is a block diagram showing the components comprising the Interface_Controller 39 that is the bridge between the RS422 NMEA_{—}0183_Navigation_Devices 1 and the Ethernet 5. The NMEA_{—}0183_Navigation_Devices 1 are devices that output and receive the standard NMEA_{—}0183_Sentence 20 data structure over a RS422 electrically compatible link. These NMEA_{—}0183_Navigation_Devices 1, NMEA_{—}0183_RS422_Inputs 6, are interfaced to this controller at the RS422_Transceiver 2 which provides for the electrical compatibility as required by the RS422 standard. This RS422_Transceiver 2 is then electrically coupled to the Microprocessor 3, which processes the NMEA_{—}0183_Data_Sentence 37 received from the RS422_Transceiver 2 and from the Ethernet_NMEA_{—}0183_Data_Packet 38. This Ethernet_NMEA_{—}0183_Data_Packet 38 is handled by the Ethernet_Transceiver 4. This Ethernet_Transceiver 4 provides for the electrical interface requirements as defined for the Ethernet 5. These electrical components are package in a container suitable for the installation location and the environment of the Interface_Controller 39 will be located in. Means shall be provided for the connections to the NMEA_{—}0183_Navigation_Devices 1 electrically, along with electrical and mechanical connection to the the Ethernet 5. In addition, allowances will be made for the connections of AC or DC power required to operate the electronics within the Interface_Controller 39.

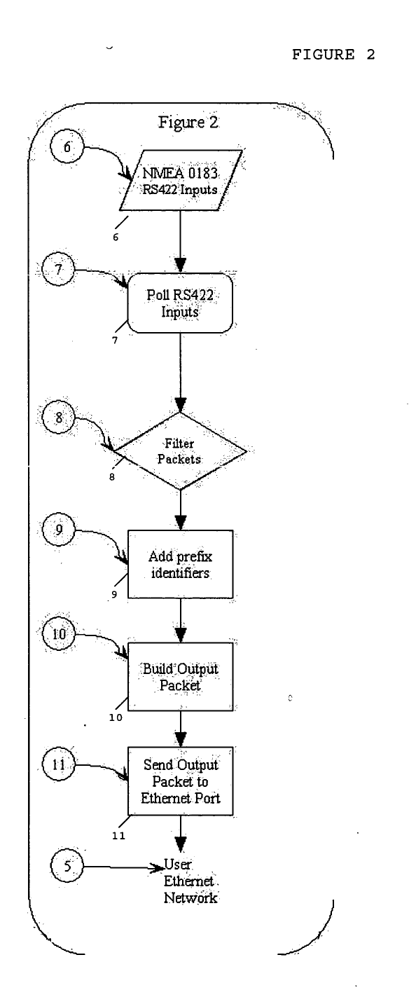

FIG. 2 is a block diagram of the input process flow view of the Interface_Controller 39. This flow is representative of logic that is programmed into the Microprocessor 3 within the Interface_Controller 39. The flow starts by the receipt of data from the NMEA_{—}0183_Navigation_Devices 1, which is referred to as the NMEA_{—}0183_RS422_Inputs 6. These NMEA_{—}0183_RS422_Inputs 6, of which there can be one or many, are polled in an endless loop by the program logic Poll_RS422_Inputs 7. Poll_RS422_Inputs 7 checks to see if a complete NMEA_{—}0183_Data_Sentence 37 has been received at this input port. If not, then Poll_RS422_Inputs 7 continues to the next input RS422 port. If the NMEA_{—}0183_Data_Sentence 37 has been completely received, then it is passed to Filter_Packets 8. Filter_Packets 8 then checks its user defined memory variables to see if there are routing instructions for this NMEA_{—}0183_Data_Sentence 37 and if there are other instructions on the handling of this NMEA_{—}0183_Data_Sentence 37. These special handling instructions then are applied by the Add_Prefix 9 program logic to create the resultant Ethernet_NMEA_{—}0183_Data_Packet 38, with the Build_Output_Packet 10 program logic. The Output_Packet 11 program logic takes the Ethernet_NMEA_{—}0183_Data_Packet 38 and writes this data to the Ethernet 5 via the Ethernet_Transceiver 4.

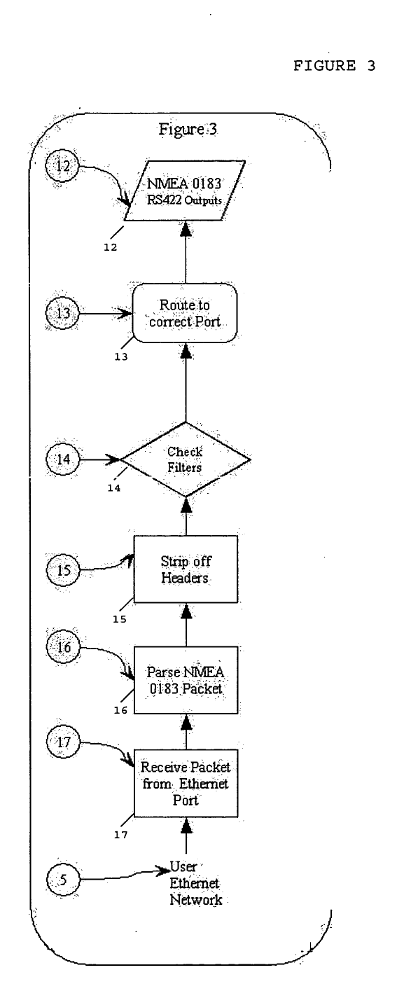

FIG. 3 is a block diagram of the output process flow view of the Interface_Controller 39. This logic flow is representative of the logic that is programmed into the Microprocessor 3 within the Interface_Controller 39. The flow starts by the receipt of the Ethernet_NMEA_{—}0183_Data_Packet 38 from the Ethernet 5 at the Ethernet_Transceiver 4. This Ethernet_NMEA_{—}0183_Data_Packet 38 is handled by the Receive_Ethernet_Packet 17 program module. The Ethernet_NMEA_{—}0183_Data_Packet 38 is then passed to the Parse_Packet 16 program module which starts to break apart the data fields. Then the data is passed to the Strip_Headers 15 program module. It is at the Strip_Headers 15 program module that the NMEA_{—}0183_Data_Sentence 37 is returned to its native format. At this stage, the Check_Filters 14 program module, checks the user stored parameters that will allow it to make decisions for the next module which is Route_to_Port 13. The Route_to_Port 13 program module determines which RS422_Transceiver 2 output port to write this NMEA_{—}0183_Sentence 20 as defined by the NMEA_{—}0183_RS422_Outputs 12.

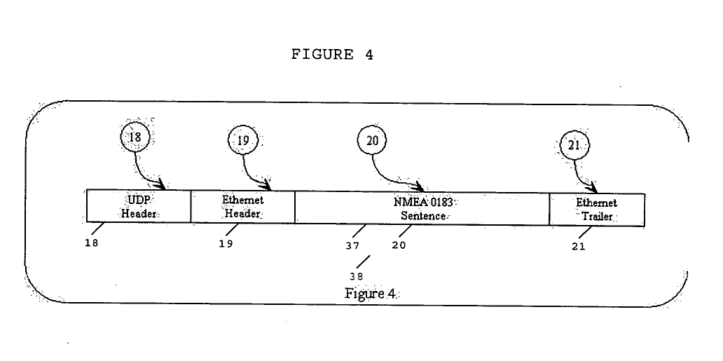

FIG. 4 is a packet diagram view of the Ethernet_NMEA_{—}0183_Data_Packet 38 created by the Interface_Controller 39 and/or created by the Software_Interface_Utility 40. This is comprised of the standard UDP_Header 18, the Ethernet_Header 19 which defines this type of packet of data, the NMEA_{—}0183_Data_Sentence 37 and the Ethernet_Trailer 21. The Ethernet_Trailer 21 will contain any significant makers which might be required to identify the end of the Ethernet_NMEA_{—}0183_Data_Packet 38.

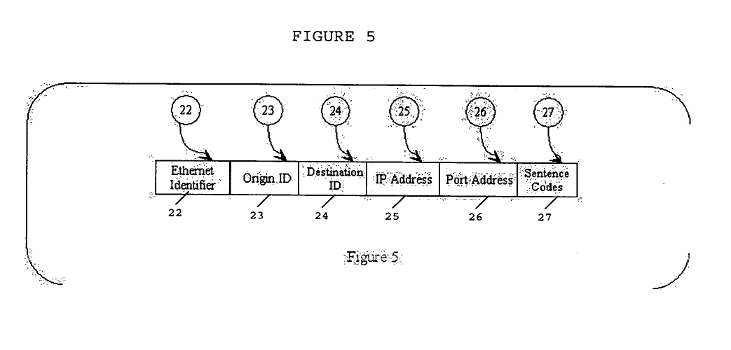

FIG. 5 is a generic data element field view of the Ethernet_Header 19 of the Ethernet_NMEA_{—}0183_Data_Packet 38 created by the Interface_Controller 39 and/or created by the Software_Interface_Utility 40. This view provides a general concept of the data fields that will comprise the Ethernet_Header 19 which is prefixed to the NMEA_{—}0183_Data_Sentence 37. The first field is the Ethernet_Identifier 22 followed by the Origin_ID 23 which is the unique identification assigned when the NMEA_{—}0183_Data_Sentence 37 is received. Next is the Destination_ID 24 that defines the port for routing this data packet to. The next two fields IP_Address 25 and Port_Address 26, of the Software_Interface_Utility 40 program that does the interfacing between the Ethernet_NMEA_{—}0183_Data_Packet 38 are used to further define the routing directions. The last field, Sentence_Codes 27, is the NMEA_{—}0183_Data_Sentence 37 identifier code, which is unique for this NMEA_{—}0183_Data_Sentence 37 and is part of the standard as published by the NMEA organization.

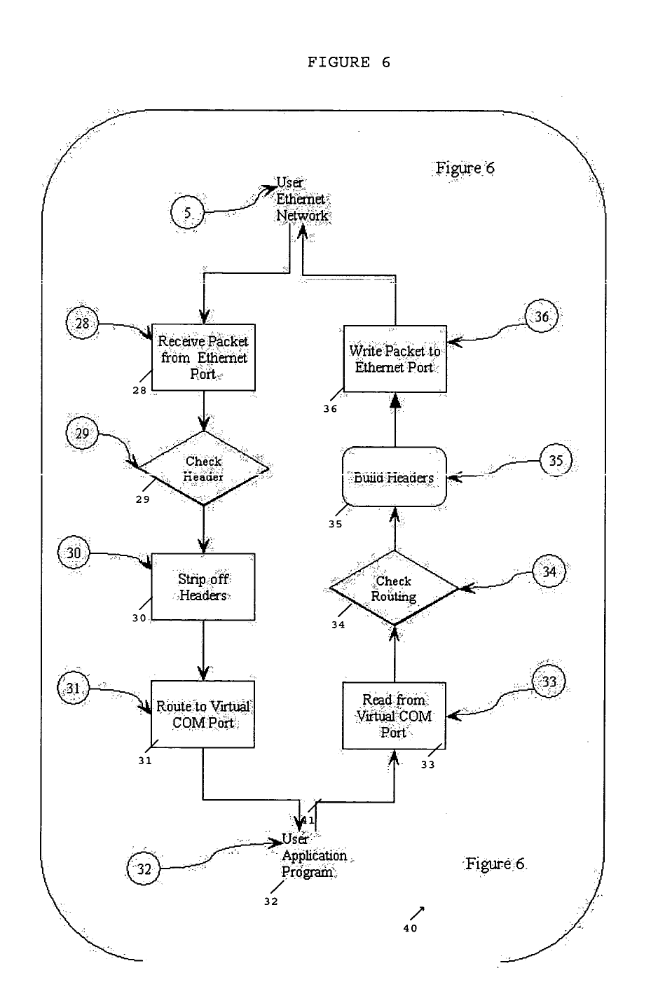

FIG. 6 is a block diagram of the the program logic of the Software_Interface_Utility 40 program that does the interfacing between the Ethernet_NMEA_{—}0183_Data_Packet 38 and the User_Applications 32 running on the user's computer. This Software_Interrace_Utility 40 will provide a GUI (Graphic User Interface) to the user for configuring and mapping of Virtual_COM_Ports 41 to the User_Applications 32. The Ethernet_NMEA_{—}0183_Data_Packet 38 is handled by the Receive_Packet 28 program routine. The Ethernet_Header 19 is processed by the Check_Header 29 program routine as it checks for information which will set its logic for the mapping and routing of the NMEA_{—}0183_Data_Sentence 37 portion of this Ethernet_NMEA_{—}0183_Data_Packet 38. Then the Strip_Headers_From_Packet 30 separates the Ethernet_NMEA_{—}0183_Data_Packet 38 back to its native form of the NMEA_{—}0183_Data_Sentence 37. The NMEA_{—}0183_Data_Sentence 37 is then passed to the Route_to_Virtual_COM_Port 31 program routine for writing the NMEA_{—}0183_Data_Sentence 37 to the correctly routed Virtual_COM_Ports 41 based upon the instructions in the Ethernet_Header 19.

The Virtual_COM_Ports 41 are also being read by the Software_Interface_Utility 40 while all the time checking for a NMEA_{—}0183_Data_Sentence 37 with the program routine Read_From_Virtual_COM_Port 33. Once a complete NMEA_{—}0183_Data_Sentence 37 is found, the program routine Check_Routing 34 is invoked to determine how to handle the routing of this NMEA_{—}0183_Data_Sentence 37. The Build_Headers 35 program routine is then used to construct the Ethernet_NMEA_{—}0183_Data_Packet 38 which will be comprised of, but not limited to the UDP_Header 18, Ethernet_Header 19, NMEA_{—}0183_Data_Sentence 37 and the Ethernet_Trailer 21. This completed Ethenet_NMEA_{—}0183_Data_Packet is then passed to the Write_Packet 36 program routine to be written to the Ethernet 5.

Thus in summary, it can be seen that the Interface_Controller 39 provides a bridge for the NMEA_{—}0183_Navigation_Devices 1 which uses the NMEA_{—}0183_Data_Sentence 37, and the Ethernet 5. While at the users computer, the Software_Interface_Utility 40 provides another bridge between the Ethernet 5 and the User_Applications 32 which use or create the NMEA_{—}0183_Data_Sentence 37. In addition, this transports the NMEA_{—}0183_Data_Sentence 37 at the high speed of the Ethernet 5 while providing transparency to the user.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

1. A nmea 0183 sentence transporter over ethernet for a nmea 0183 sentence transporter over ethernet for increasing transmission speed, allowing for dynamic routing and complete transparency to the user. comprising:
means for converting the electrical signals from rs422 to microprocessor level signal levels and then from the microprocessor signal levels to rs422 electrical signal standards;
means for processing the software instructions for transporting the nmea 0183 sentances and the routing instructions, electrically connected to said means for converting the electrical signals from rs422 to microprocessor level signal levels and then from the microprocessor signal levels to rs422 electrical signal standards;
means for providing the compatablitity with ethernet signals levels and the microprocessor signal levels, electrically connected to said means for processing the software instructions for transporting the nmea 0183 sentances and the routing instructions;
means for indentifying input processing of the nmea 0183 data;
means for polling routine that is to cycle through each of the input ports looking for nmea 0183 sentences, logically linked to said means for indentifying input processing of the nmea 0183 data;
means for a checking routine that filters out nmea 0183 sentences that are not to be transported to the ethernet, logically linked to said means for polling routine that is to cycle through each of the input ports looking for nmea 0183 sentences;
means for adding a prefix header to the ethernet sentence packet, logically linked to said means for a checking routine that filters out nmea 0183 sentences that are not to be transported to the ethernet;
means for building an ethernet data packet comprised of the header fields and the nmea 0183 sentence, logically linked to said means for adding a prefix header to the ethernet sentence packet;
means for processing the ethernet data packet by submitting it to the output driver, logically linked to said means for building an ethernet data packet comprised of the header fields and the nmea 0183 sentence;
means for writing the nmea 0183 data sentence to the correct output port;
means for routing the nmea 0183 data packet to the correct rs422 port, logically linked to said means for writing the nmea 0183 data sentence to the correct output port;
means for checking data filters to see if nmea 0183 sentence data should be sent to output ports, logically linked to said means for routing the nmea 0183 data packet to the correct rs422 port;
means for stripping off headers from the ethernet nmea 0183 data sentence packet, logically linked to said means for checking data filters to see if nmea 0183 sentence data should be sent to output ports;
means for parsing the packet to determine the routing for the nmea 0183 sentence, logically linked to said means for stripping off headers from the ethernet nmea 0183 data sentence packet;
means for polling the ethernet packet looking for nmea 0183 encapsulated data, logically linked to said means for parsing the packet to determine the routing for the nmea 0183 sentence;
means for defining data which makes up the udp header, including the ip address;
means for defining data which encapsulates the prefix of the nmea 0183 sentence data, containing but not limited to indentifications, and routing;
means for defining data which makes up the standard nmea 0183 sentence;
means for defining the data suffix added to the nmea 0183 sentence;
means for defining the data field that makes up the unique indetifier for the ethernet data packet;
means for defining the data field which defines the origin id fof the data sentence;
means for defining the data field of the destination id for the data packet;
means for defining the data field of the destination ip address for the ethernet data packet;
means for defining the data field of the destination port address for the ethernet data packet;
means for defining the data field that which is made up of the nmea 0183 sentence code for this ethernet data packet;
means for reading the ethernet packet of data from the transparancy program running on the computer;
means for checking headers for routing and mapping instructions, logically linked to said means for reading the ethernet packet of data from the transparancy program running on the computer;
means for stripping off the header from the ethernet packet, logically linked to said means for checking headers for routing and mapping instructions;
means for routing and writting of the nmea 0183 sentence to the correct virtual com port, logically linked to said means for stripping off the header from the ethernet packet;
means for reading from the virtual com port and looking for a valid nmea 0183 sentence;
means for checking the routing and mapping table to determine what header intructions to build, logically linked to said means for reading from the virtual com port and looking for a valid nmea 0183 sentence;
means for constructing the header on the front of the nmea 0183 sentence which contains the routing and indentification information, logically linked to said means for checking the routing and mapping table to determine what header intructions to build;
means for writting the nmea 0183 packet containing headers and trailers to the ethernet, logically linked to said means for constructing the header on the front of the nmea 0183 sentence which contains the routing and indentification information;
means for defining the data that is used for ethernet transmission of the nmea 0183 data sentence; and
means for interfacing between the software interface utility and the user applications.

2. The nmea 0183 sentence transporter over ethernet in accordance with claim 1, wherein said means for converting the electrical signals from rs422 to microprocessor level signal levels and then from the microprocessor signal levels to rs422 electrical signal standards comprises a RS422 electro static protection rs422_transceiver.

3. The nmea 0183 sentence transporter over ethernet in accordance with claim 1, wherein said means for processing the software instructions for transporting the nmea 0183 sentances and the routing instructions comprises a Microprocessor capable of interfacing to RS422 transceiver and Ethernet tranceiver electrically, Microprocessor capable of being programmed with logic as stated microprocessor.

4. The nmea 0183 sentence transporter over ethernet in accordance with claim 1, wherein said means for providing the compatablitity with ethernet signals levels and the microprocessor signal levels comprises an Electrically compatable interface between microprocessor and standard Ethernet signal levels ethernet_transceiver.

5. The nmea 0183 sentence transporter over ethernet in accordance with claim 1, wherein said means for indentifying input processing of the nmea 0183 data comprises a nmea_{—}0183_rs422_inputs.

6. The nmea 0183 sentence transporter over ethernet in accordance with claim 1, wherein said means for polling routine that is to cycle through each of the input ports looking for nmea 0183 sentences comprises a poll_rs422_inputs.

7. The nmea 0183 sentence transporter over ethernet in accordance with claim 1, wherein said means for a checking routine that filters out nmea 0183 sentences that are not to be transported to the ethernet comprises a filter_packets.

8. The nmea 0183 sentence transporter over ethernet in accordance with claim 1, wherein said means for adding a prefix header to the ethernet sentence packet comprises an add_prefix.

9. The nmea 0183 sentence transporter over ethernet in accordance with claim 1, wherein said means for building an ethernet data packet comprised of the header fields and the nmea 0183 sentence comprises a build_output_packet.

10. The nmea 0183 sentence transporter over ethernet in accordance with claim 1, wherein said means for processing the ethernet data packet by submitting it to the output driver comprises an output_packet.

11. The nmea 0183 sentence transporter over ethernet in accordance with claim 1, wherein said means for writing the nmea 0183 data sentence to the correct output port comprises a nmea_{—}0183_rs422_outputs.

12. The nmea 0183 sentence transporter over ethernet in accordance with claim 1, wherein said means for routing the nmea 0183 data packet to the correct rs422 port comprises a route_to_port.

13. The nmea 0183 sentence transporter over ethernet in accordance with claim 1, wherein said means for checking data filters to see if nmea 0183 sentence data should be sent to output ports comprises a check_filters.

14. The nmea 0183 sentence transporter over ethernet in accordance with claim 1, wherein said means for stripping off headers from the ethernet nmea 0183 data sentence packet, comprises a strip_headers.

15. The nmea 0183 sentence transporter over ethernet in accordance with claim 1, wherein said means for parsing the packet to determine the routing for the nmea 0183 sentence comprises a parse_packet.

16. The nmea 0183 sentence transporter over ethernet in accordance with claim 1, wherein said means for polling the ethernet packet looking for nmea 0183 encapsulated data comprises a receive_ethernet_packet.

17. The nmea 0183 sentence transporter over ethernet in accordance with claim 1, wherein said means for defining data which makes up the udp header, including the ip address comprises an udp_header.

18. The nmea 0183 sentence transporter over ethernet in accordance with claim 1, wherein said means for defining data which encapsulates the prefix of the nmea 0183 sentence data, containing but not limited to indentifications, and routing comprises an ethernet_header.

19. The nmea 0183 sentence transporter over ethernet in accordance with claim 1, wherein said means for defining the data suffix added to the nmea 0183 sentence comprises an ethernet_trailer.

20. The nmea 0183 sentence transporter over ethernet in accordance with claim 1, wherein said means for defining the data field that makes up the unique indetifier for the ethernet data packet comprises an ethernet_identifier.

21. The nmea 0183 sentence transporter over ethernet in accordance with claim 1, wherein said means for defining the data field which defines the origin id fof the data sentence comprises an origin_id.

22. The nmea 0183 sentence transporter over ethernet in accordance with claim 1, wherein said means for defining the data field of the destination id for the data packet comprises a destination_id.

23. The nmea 0183 sentence transporter over ethernet in accordance with claim 1, wherein said means for defining the data field of the destination ip address for the ethernet data packet comprises an ip_address.

24. The nmea 0183 sentence transporter over ethernet in accordance with claim 1, wherein said means for defining the data field of the destination port address for the ethernet data packet comprises a port_address.

25. The nmea 0183 sentence transporter over ethernet in accordance with claim 1, wherein said means for defining the data field that which is made up of the nmea 0183 sentence code for this ethernet data packet comprises a sentence_codes.

26. The nmea 0183 sentence transporter over ethernet in accordance with claim 1, wherein said means for reading the ethernet packet of data from the transparancy program running on the computer comprises a receive_packet.

27. The nmea 0183 sentence transporter over ethernet in accordance with claim 1, wherein said means for checking headers for routing and mapping instructions comprises a check_header.

28. The nmea 0183 sentence transporter over ethernet in accordance with claim 1, wherein said means for stripping off the header from the ethernet packet comprises a strip_headers_from_packet.

29. The nmea 0183 sentence transporter over ethernet in accordance with claim 1, wherein said means for routing and writting of the nmea 0183 sentence to the correct virtual com port comprises a route_to_virtual_com_port.

30. The nmea 0183 sentence transporter over ethernet in accordance with claim 1, wherein said means for reading from the virtual com port and looking for a valid nmea 0183 sentence comprises a read_from_virtual_com_port.

31. The nmea 0183 sentence transporter over ethernet in accordance with claim 1, wherein said means for checking the routing and mapping table to determine what header instructions to build comprises a check_routing.

32. The nmea 0183 sentence transporter over ethernet in accordance with claim 1, wherein said means for constructing the header on the front of the nmea 0183 sentence which contains the routing and indentification information comprises a build_headers.

33. The nmea 0183 sentence transporter over ethernet in accordance with claim 1, wherein said means for writting the nmea 0183 packet containing headers and trailers to the ethernet comprises a write_packet.

34. The nmea 0183 sentence transporter over ethernet in accordance with claim 1, wherein said means for defining the data that is used for ethernet transmission of the nmea 0183 data sentence comprises an ethernet_nmea_{—}0183_data_packet.

35. The nmea 0183 sentence transporter over ethernet in accordance with claim 1, wherein said means for interfacing between the software interface utility and the user applications comprises a virtual_com_ports.

36. A nmea 0183 sentence transporter over ethernet for a nmea 0183 sentence transporter over ethernet for increasing transmission speed, allowing for dynamic routing and complete transparency to the user. comprising:
a RS422 electro static protection rs422_transceiver, for converting the electrical signals from rs422 to microprocessor level signal levels and then from the microprocessor signal levels to rs422 electrical signal standards;
a Microprocessor capable of interfacing to RS422 transceiver and Ethernet tranceiver electrically, Microprocessor capable of being programmed with logic as stated microprocessor, for processing the software instructions for transporting the nmea 0183 sentances and the routing instructions, electrically connected to said RS422_Transceiver;
an Electrically compatable interface between microprocessor and standard Ethernet signal levels ethernet_transceiver, for providing the compatablitity with ethernet signals levels and the microprocessor signal levels, electrically connected to said Microprocessor;
a nmea_{—}0183_rs422_inputs, for indentifying input processing of the nmea 0183 data;
a poll_rs422_inputs, for polling routine that is to cycle through each of the input ports looking for nmea 0183 sentences, logically linked to said NMEA_{—}0183_RS422_Inputs;
a filter_packets, for a checking routine that filters out nmea 0183 sentences that are not to be transported to the ethernet, logically linked to said Poll_RS422_Inputs;
an add_prefix, for adding a prefix header to the ethernet sentence packet, logically linked to said Filter_Packets;
a build_output_packet, for building an ethernet data packet comprised of the header fields and the nmea 0183 sentence, logically linked to said Add_Prefix;
an output_packet, for processing the ethernet data packet by submitting it to the output driver, logically linked to said Build_Output_Packet;
a nmea_{—}0183_rs422_outputs, for writing the nmea 0183 data sentence to the correct output port;
a route_to_port, for routing the nmea 0183 data packet to the correct rs422 port, logically linked to said NMEA_{—}0183_RS422_Outputs;
a check_filters, for checking data filters to see if nmea 0183 sentence data should be sent to output ports, logically linked to said Route_to_Port;
a strip_headers, for stripping off headers from the ethernet nmea 0183 data sentence packet, logically linked to said Check_Filters;
a parse_packet, for parsing the packet to determine the routing for the nmea 0183 sentence, logically linked to said Strip_Headers;
a receive_ethernet_packet, for polling the ethernet packet looking for nmea 0183 encapsulated data, logically linked to said Parse_Packet;
an udp_header, for defining data which makes up the udp header, including the ip address;
an ethernet_header, for defining data which encapsulates the prefix of the nmea 0183 sentence data, containing but not limited to indentifications, and routing;
a nmea_{—}0183_sentence, for defining data which makes up the standard nmea 0183 sentence;
an ethernet_trailer, for defining the data suffix added to the nmea 0183 sentence;
an ethernet_identifier, for defining the data field that makes up the unique indetifier for the ethernet data packet;
an origin_id, for defining the data field which defines the origin id fof the data sentence;
a destination_id, for defining the data field of the destination id for the data packet;
an ip_address, for defining the data field of the destination ip address for the ethernet data packet;
a port_address, for defining the data field of the destination port address for the ethernet data packet;
a sentence_codes, for defining the data field that which is made up of the nmea 0183 sentence code for this ethernet data packet;
a receive_packet, for reading the ethernet packet of data from the transparancy program running on the computer;
a check_header, for checking headers for routing and mapping instructions, logically linked to said Receive_Packet;
a strip_headers_from_packet, for stripping off the header from the ethernet packet, logically linked to said Check_Header;
a route_to_virtual_com_port, for routing and writting of the nmea 0183 sentence to the correct virtual com port, logically linked to said Strip_Headers_From_Packet;
a read_from_virtual_com_port, for reading from the virtual com port and looking for a valid nmea 0183 sentence;
a check_routing, for checking the routing and mapping table to determine what header intructions to build, logically linked to said Read_From_Virtual_COM_Port;
a build_headers, for constructing the header on the front of the nmea 0183 sentence which contains the routing and indentification information, logically linked to said Check_Routing;
a write_packet, for writting the nmea 0183 packet containing headers and trailers to the ethernet, logically linked to said Build_Headers;
an ethernet_nmea_{—}0183_data_packet, for defining the data that is used for ethernet transmission of the nmea 0183 data sentence; and
a virtual_com_ports, for interfacing between the software interface utility and the user applications.

37. The nmea 0183 sentence transporter over ethernet as recited in claim 36, further comprising:
an user_applications, for applications that are user supplied needing access to the nmea 0183 data and operating on the computer, logically connected to said Route_to_Virtual_COM_Port, and logically connected to said Read_From_Virtual_COM_Port.

38. A nmea 0183 sentence transporter over ethernet for a nmea 0183 sentence transporter over ethernet for increasing transmission speed, allowing for dynamic routing and complete transparency to the user. comprising:
a RS422 electro static protection rs422_transceiver, for converting the electrical signals from rs422 to microprocessor level signal levels and then from the microprocessor signal levels to rs422 electrical signal standards;
a Microprocessor capable of interfacing to RS422 transceiver and Ethernet tranceiver electrically, Microprocessor capable of being programmed with logic as stated microprocessor, for processing the software instructions for transporting the nmea 0183 sentances and the routing instructions, electrically connected to said RS422_Transceiver;
an Electrically compatable interface between microprocessor and standard Ethernet signal levels ethernet_transceiver, for providing the compatablitity with ethernet signals levels and the microprocessor signal levels, electrically connected to said Microprocessor;
a nmea_{—}0183_rs422_inputs, for indentifying input processing of the nmea 0183 data;
a poll_rs422_inputs, for polling routine that is to cycle through each of the input ports looking for nmea 0183 sentences, logically linked to said NMEA_{—}0183_RS422_Inputs;
a filter_packets, for a checking routine that filters out nmea 0183 sentences that are not to be transported to the ethernet, logically linked to said Poll_RS422_Inputs;
an add_prefix, for adding a prefix header to the ethernet sentence packet, logically linked to said Filter_Packets;
a build_output_packet, for building an ethernet data packet comprised of the header fields and the nmea 0183 sentence, logically linked to said Add_Prefix;
an output_packet, for processing the ethernet data packet by submitting it to the output driver, logically linked to said Build_Output_Packet;
a nmea_{—}0183_rs422_outputs, for writing the nmea 0183 data sentence to the correct output port;
a route_to_port, for routing the nmea 0183 data packet to the correct rs422 port, logically linked to said NMEA_{—}0183_RS422_Outputs;
a check_filters, for checking data filters to see if nmea 0183 sentence data should be sent to output ports, logically linked to said Route_to_Port;
a strip_headers, for stripping off headers from the ethernet nmea 0183 data sentence packet, logically linked to said Check_Filters;
a parse_packet, for parsing the packet to determine the routing for the nmea 0183 sentence, logically linked to said Strip_Headers;
a receive_ethernet_packet, for polling the ethernet packet looking for nmea 0183 encapsulated data, logically linked to said Parse_Packet;
an udp_header, for defining data which makes up the udp header, including the ip address;
an ethernet_header, for defining data which encapsulates the prefix of the nmea 0183 sentence data, containing but not limited to indentifications, and routing;
a nmea_{—}0183_sentence, for defining data which makes up the standard nmea 0183 sentence;
an ethernet_trailer, for defining the data suffix added to the nmea 0183 sentence;
an ethernet_identifier, for defining the data field that makes up the unique indetifier for the ethernet data packet;
an origin_id, for defining the data field which defines the origin id fof the data sentence;
a destination_id, for defining the data field of the destination id for the data packet;
an ip_address, for defining the data field of the destination ip address for the ethernet data packet;
a port_address, for defining the data field of the destination port address for the ethernet data packet;
a sentence_codes, for defining the data field that which is made up of the nmea 0183 sentence code for this ethernet data packet;
a receive_packet, for reading the ethernet packet of data from the transparancy program running on the computer;
a check_header, for checking headers for routing and mapping instructions, logically linked to said Receive_Packet;
a strip_headers_from_packet, for stripping off the header from the ethernet packet, logically linked to said Check_Header;
a route_to_virtual_com_port, for routing and writting of the nmea 0183 sentence to the correct virtual com port, logically linked to said Strip_Headers_From_Packet;
an user_applications, for applications that are user supplied needing access to the nmea 0183 data and operating on the computer, logically connected to said Route_to_Virtual_COM_Port;
a read_from_virtual_com_port, for reading from the virtual com port and looking for a valid nmea 0183 sentence, logically connected to said User_Applications;
a check_routing, for checking the routing and mapping table to determine what header intructions to build, logically linked to said Read_From_Virtual_COM_Port;
a build_headers, for constructing the header on the front of the nmea 0183 sentence which contains the routing and indentification information, logically linked to said Check_Routing;
a write_packet, for writting the nmea 0183 packet containing headers and trailers to the ethernet, logically linked to said Build_Headers;
an ethernet_nmea_{—}0183_data_packet, for defining the data that is used for ethernet transmission of the nmea 0183 data sentence; and
a virtual_com_ports, for interfacing between the software interface utility and the user applications.
